(19) United States
(12) Patent Application Publication
(10) Pub. No.: US 2015/0066706 A1
(43) Pub. Date: Mar. 5, 2015

(54) MATTRESS PURCHASE SYSTEM AND METHOD ESTABLISHED BASED ON PHYSIOLOGICAL RESPONSES AND SUBJECTIVE EVALUATION DATA

(71) Applicants: Mao-Jiun WANG, Hsinchu City (TW); Chih-Yun Lee, Hsinchu City (TW); Chia-Ching Tsai, New Taipei City (TW)

(72) Inventors: Mao-Jiun WANG, Hsinchu City (TW); Chih-Yun Lee, Hsinchu City (TW); Chia-Ching Tsai, New Taipei City (TW)

(73) Assignee: NATIONAL TSING HUA UNIVERSITY, Hsinchu City (TW)

(21) Appl. No.: 14/061,224

(22) Filed: Oct. 23, 2013

(30) Foreign Application Priority Data
Aug. 30, 2013 (TW) 102131208

(51) Int. Cl. G06Q 30/06

(52) U.S. Cl. CPC G06Q 30/0631; G06Q 30/0627
USPC 705/26.63

(57) ABSTRACT

A mattress purchase system and method established based on physiological responses and subjective evaluation data is implemented via a computer device to assist customers in selecting and purchasing most suitable mattress products. The mattress purchase system includes a mattress database, a physiological responses database, an integrated operation processing unit, an adjustment parameter selector module, and a display interface used to output and display body parameter values, preliminary data of appropriate mattress sequence and the final suggested mattress data. The mattress purchase system enables customers to select the most suitable mattresses quickly and accurately, and improves the performance of salesman with better practicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a purchase system and method, and more particularly to an innovative mattress purchase system and method designed tot benefit of customers.

2. Description of Related Art Including Information Disclosed Under 37 CFR 1.97 and 37 CFR 1.98

Sleep quality has a considerable impact on human health, and most people's sleep time accounts for ⅓ of the day since sleep is the most effective way for the relaxation of the brain and the body. Thus, high quality sleep .an make people feel sober-minded and refreshed, but also plays a big role of improving the efficiency of work and study.

To acquire top quality sleep, the mattress is a crucial influential factor in addition to the Individual's own mental and emotional factors, as well as the quality of surrounding environment. If we choose a proper mattress, it is possible to improve the quality of sleep, but also ameliorate common diseases in modem civilization, such as backache.

The mattress product structure has undergone development and design for decades. Numerous individuals and enterprises are engaged in the development and marketing of mattress products based on existing and fairly mature technology. In view of fierce competition nowadays, great concern is raised to improvement of the products, the quality of service, service level and the fit between the customers and the products, so as to win the attraction and support of the customers.

Through continuous R&D and improvement in the industry, there exist different structures of mattress products in terms of appearance, dimensions, materials, special supporting points, hardness-softness, air permeability, patterns, and colors. Therefore, when a customer goes shopping in a store with numerous mattress products, undoubtedly the customer will find it difficult to pick out a proper one out of dozens or even hundreds of products. This will surely become a time-consuming process for the customers and sales staff, resulting in a waste of time and lower efficiency.

Another problem occurs when a customer intends to select a mattress product. Since it usually takes a little time to have a try on the mattress, the customer may find it improper after a prolonged time use. This problem is also a blind spot in purchasing a mattress currently.

Thus, to overcome the aforementioned problems of the prior art, it would be an advancement in the art, to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention is based on physiological responses and subjective evaluation data and enables the customers to select the most suitable mattresses quickly and accurately by calculating appropriate mattress hardness-softness and personal preference, thus significantly improving performance of the mattress salesman. The present invention adopts a two-phase selection mode, allowing for removal of unsuitable mattresses when getting the preliminary data of appropriate mattress sequences, thus improving the operation efficiency of getting the final suggested mattress data. The present invention can provide related companies with a utility system and methods or techniques of manufacturing mattresses, so as to meet the customer demands, improve mattress industry competitiveness and efficiency with better practicability and industry benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a text block diagram of mattress purchase system of the present invention.

FIG. 2 is a text block diagram of mattress purchasing method of the present invention.

FIG. 3 is a schematic drawing of mattress purchase sorting table of the present invention.

FIG. 4 is a step drawing 1 of the present invention wherein the adjustment parameter selection means is added into the mattress purchase method.

FIG. 5 is a step drawing 2 of the present invention wherein the adjustment parameter selection means is added into the mattress purchase method.

FIG. 6 is the steps drawing 3 of the present invention wherein the adjustment parameter selection means is added into the mattress purchase method.

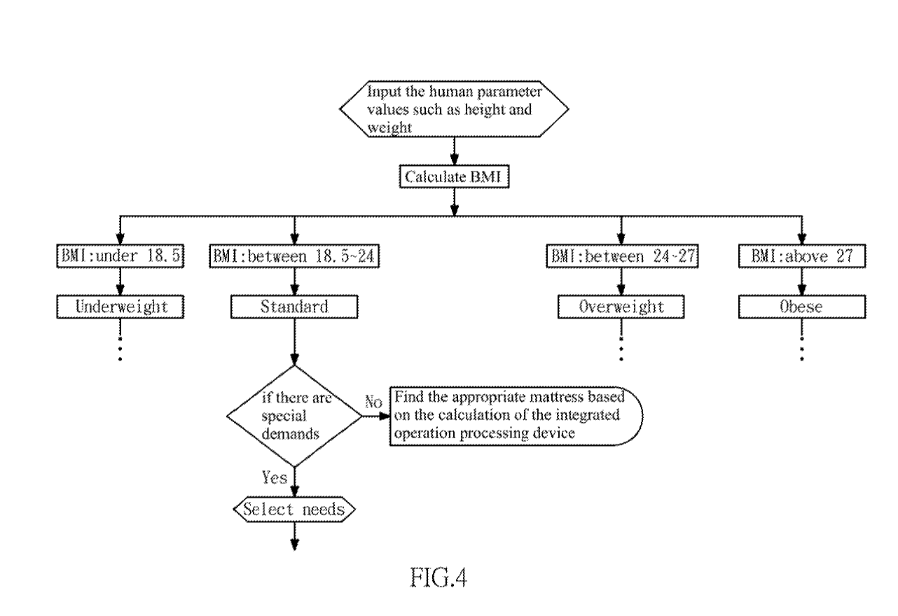

Note that FIGS. 4, 5 and 6 are different drawings for the same operating step, and the contents in each drawing are partially overlapped.

### DETAILED DESCRIPTION OF THE INVENTION

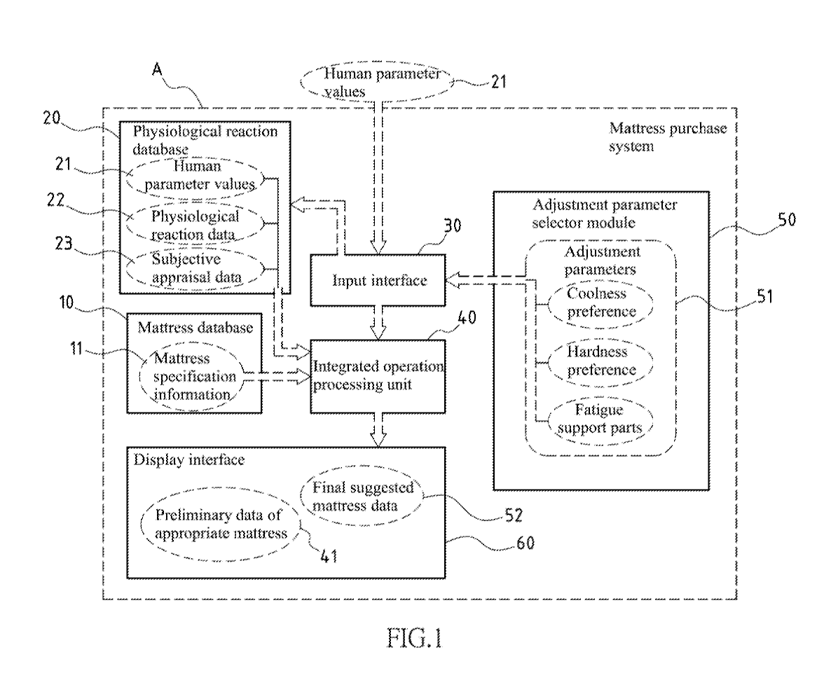

FIG. 1 depicts a preferred, embodiment of the mattress purchase system and method of the present invention established based on physiological responses and subjective evaluation data, which, however, is provided for only explanatory objective for patent claims. Said mattress purchase system is implemented via a computer device to assist customers in selecting and purchasing the most suitable mattress products.

Said mattress purchase system A includes a mattress database 10, which is used to store multiple mattress specification information 11.

A physiological responses database 20 is used to store customers' gender, height, weight and other body parameter values 21, as well as average pressure, pressure uniformity, average temperature, temperature uniformity. EMG and other physiological responses data 22, as well as subjective evaluation data 23. Said subjective evaluation data. includes subjective comfort questionnaire parameters and subjective discomfort questionnaire parameters.

An input interface 30 is used to input the customers body parameter values 21, physiological responses data 22 and subjective evaluation data 23.

An integrated operation processing unit 40 is electrically connected with the mattress database 10 and physiological responses database 20 for operation based on the body parameter values 21 and for comparison with mattress specification information 11 stored. in the mattress database 10, physiological responses data 22 and subjective evaluation data 23 stored in physiological responses database 20 to obtain the preliminary data of appropriate mattress sequence 41.

An adjustment parameter selector module 50 is used for single or multiple input via the input interface 30 based on the customer's individual mattress demands, including: preference for coolness, hardness-softness, body parts in torso and extremities vulnerable to soreness, fatigue support parts and other adjustment parameters 51. Said adjustment parameters 51 are transferred to the integrated operation processing unit 40 for operational adjustment, so as to automatically provide the final suggested mattress data 52.

A display interface 60 is used to output and display the body parameter values 21, preliminary data of appropriate mattress sequence 41 and the final suggested mattress data 52.

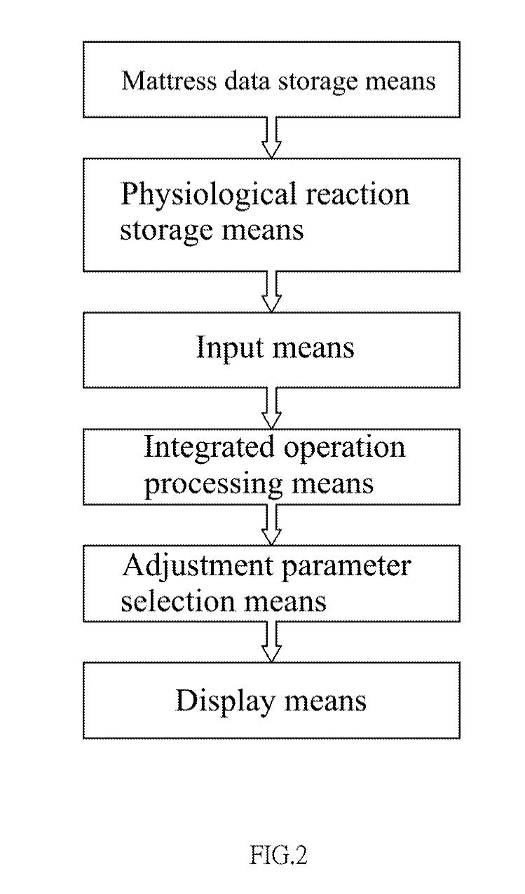

Next, the mattress purchase method of the present invention comprises the following means, referring to FIG. 2: a mattress data storage means: an input means; an integrated operation processing means; an adjustment parameter selection means; and a display means.

The mattress data storage means is used to store multiple mattress specification information.

The physiological responses storage means is used to store the customers gender, height, weight and other body parameter values, as well as average pressure value, pressure uniformity, average temperature, temperature uniformity, EMG and other physiological responses data, as well as subjective evaluation data. Said subjective evaluation data can include: subjective comfort questionnaire parameters and subjective discomfort questionnaire parameters.

The input means is used to input the customer's body parameter values, physiological responses data and subjective evaluation data.

The integrated operation processing means is used for operation based. on the body parameter values input by the input means and for comparison with mattress specification information stored in the mattress database, physiological responses data and subjective evaluation data stored in physiological responses database, so as to obtain the preliminary data of appropriate mattress sequence.

The adjustment parameter selection means is used for single or multiple input based on the customer's individual mattress demands, including: preference for coolness, hardness-softness, body parts in torso and extremities vulnerable to soreness, fatigue support parts and other adjustment parameters. Said adjustment parameters are transferred to the integrated operation processing unit for operational adjustment, so as to automatically provide the final suggested mattress data.

A display means is used to output and display the body parameter values, preliminary data of appropriate mattress sequence and the final suggested mattress data.

Of which, said body parameter values include: the customers gender, height, weight and other human parameters, or the customer's Body Mass Index (BMI).

Of which, said mattress specification information include: mattress thickness, hardness-softness, materials and sizes, including length, width and thickness.

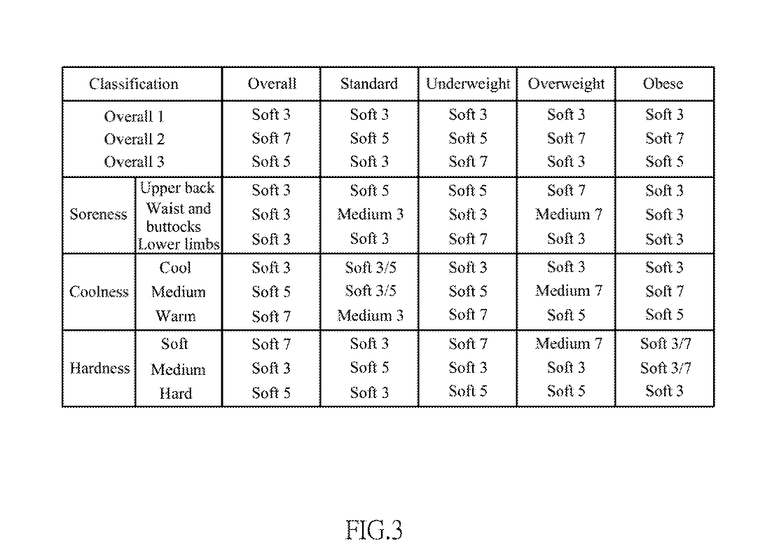

Of which, said adjustment parameter selection means could be implemented before or after getting the preliminary data of appropriate mattress sequence with the integrated operation processing means. The difference therein can be illustrated by the mattress purchase and sorting table (shown in FIG. 3). ht this table, the top field is a sorting column, wherein “All” refers to the situations without consideration of body type and “Normal”, “Underweight” and “Overweight” and “Obesity” refer to the body type. In the second column, “the first in overall ranking”, “the second in overall ranking” and other sorting results presented therein it to the preliminary data of appropriate mattress sequences with integrated operation processing method, and this part only takes the customers body parameter values as the operation results. “Soft 3”, “Soft 5” and “Medium 7”, represent mattresses of different specifications. The adjustment parameters such as preference for coolness, hardness-softness and body parts in torso and extremities vulnerable to soreness, listed in the final suggested mattress data, are sorted in the table based on “soreness”, “coolness” and “hardness-softness”, thereby obtaining more accurate mattress information for selection and purchase to meet the customers demands.

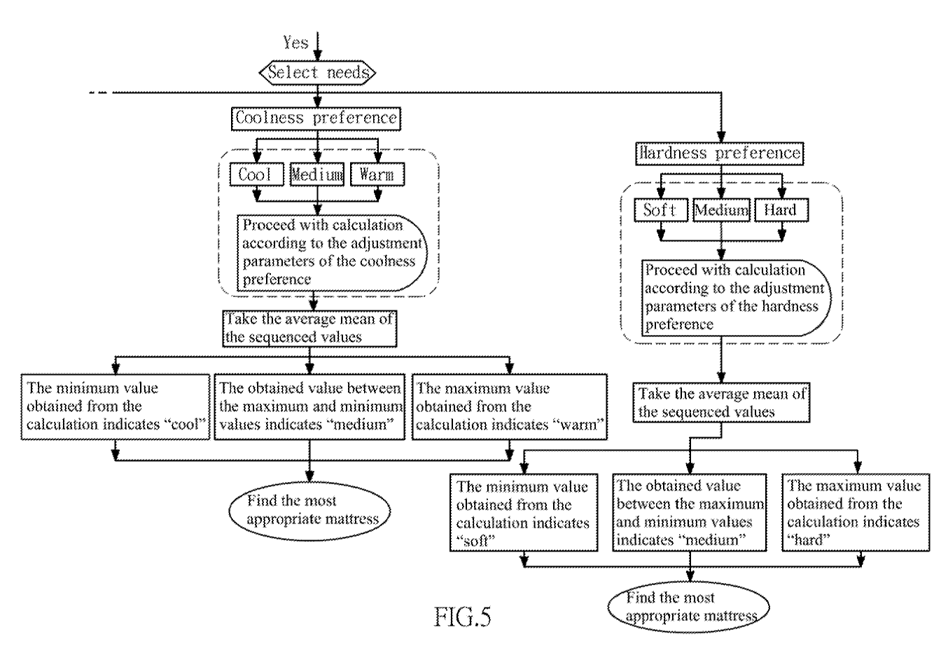

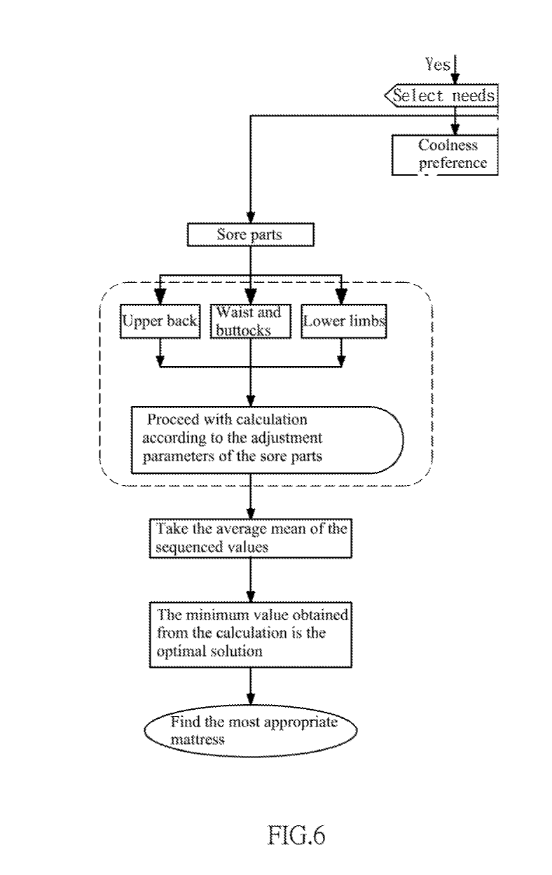

FIGS. 4, 5, and 6 illustrate detailed operating steps of the mattress purchase method of the present invention with addition of adjustment parameter selection means, of which FIG. 4 represents the forepart operating steps. First, after the customer inputs the body parameter values such as height and weight, the system can calculate BMI based on body parameter values and the body type of customer in accordance with BMI, and then proceed to the next step if there are special demands (if selecting adjustment parameters). If the customer has no special demands, the integrated operation processing means could be used to obtain the preliminary data of appropriate mattress sequence, so general appropriate mattress data can be indicated as listed in column 2 of FIG. 3. Then, as shown in FIGS. 5 and 6, if the customer has special demands, different adjustment parameters could be selected based on “soreness, “coolness” and “hardness-softness” in different preference options, such as “cool”, “moderate”, “warm” in “coolness” options. After selection of these items, the system will adjust the operations according to the selected adjustment parameters, automatically obtaining the final suggested mattress data as indicated, in the lower field of mattress purchase sorting table in FIG. 3. It is worthy to note that the aforementioned selection method of different preferences can be used as individual operation mode by selecting local options, or used as integrated operation mode by selecting all options.

Of which, said mattress purchase method may further comprise a feeling data feedback means, which is used to input and store the feelings of customers as one parameter of the subjective evaluation data, thus allowing to improve the objective accuracy of the subjective evaluation data gradually along with more customers' feedback.

We claim:

1. A mattress purchase system established based on physiological responses and subjective evaluation data, which is implemented via a computer device to assist customers in selecting and purchasing most suitable mattress products; said mattress purchase system comprising:
a mattress database, which is used to store multiple mattress specification information;
a physiological responses database, which is used to store customers gender, height, weight and other body parameter values, as well as average pressure, pressure uniformity, average temperature, temperature uniformity, EMG and other physiological responses data, as well as subjective evaluation data; said subjective evaluation data include subjective comfort questionnaire parameters and subjective discomfort questionnaire parameters;
an input interface, used to input the customers' body parameter values, physiological reaction data and subjective evaluation data;
an integrated operation processing unit, electrically connected with the mattress database and physiological responses database for operation based on the both parameter values and for comparison with mattress specification information stored in the mattress database, physiological responses data and subjective evaluation data stored in physiological responses database to obtain the preliminary data of appropriate mattress sequence;
an adjustment parameter selector module, used for single or multiple input based on the customer's individual mattress demands, including: preference for coolness, hardness-softness, body parts in torso and extremities vulnerable to soreness, fatigue support parts and other adjustment parameters; said adjustment parameters are transferred to the integrated operation processing unit for operational adjustment, so as to automatically gain the final suggested mattress data; and
a display interface, used to output and display the body parameter values, preliminary data of appropriate mattress sequence and the final suggested mattress data.

2. The system defined in claim 1, wherein said human parameters include the customer's gender, height, weight and other human parameters, or the customer's Body Mass Index (BMI).

3. The system defined in claim 1, wherein said mattress specification information includes: mattress thickness, hardness-softness, materials and size.

4. The system defined in claim 1, wherein said subjective comfort questionnaire parameters of subjective evaluation data include: overall satisfaction, coolness, support level and fitness, the subjective discomfort questionnaire parameters include overall discomfort, discomfort after two hours, discomfort of different body parts and other parameters.

5. A mattress purchase method established based on physiological responses and subjective evaluation data, which is implemented via a computer device to assist the customers in selecting and purchasing most suitable mattress products; it comprises:
multiple mattress specification information using a mattress data storage means;
storing, using a physiological responses data storage means, the customers gender, height, weight and other body parameter values, as well as average pressure value, pressure uniformity, average temperature, temperature uniformity, EMG and other physiological responses data, as well as subjective evaluation data; said subjective evaluation data include: subjective comfort questionnaire parameters and subjective discomfort questionnaire parameters;
inputting the customer's body parameter values, physiological responses data and subjective evaluation data;
using an integrated operation processing means, for operation based on the body parameter values input by the input means and for comparison with mattress specification information stored in the mattress database, physiological responses data and subjective evaluation data stored in physiological responses database, so as to obtain the preliminary data of appropriate mattress sequence;
using an adjustment parameter selection means for single or multiple input based on the customer's individual mattress demands, including: preference for coolness. hardness-softness, body parts in torso and extremities vulnerable to soreness, fatigue support parts and other adjustment parameters; said adjustment parameters are transferred to the integrated operation processing unit for operational adjustment, so as to automatically gain the final suggested mattress data;
outputting and displaying, using a display means, the body parameter values, preliminary data of appropriate mattress sequence and the final suggested mattress data.

6. The method defined in claim 5, wherein said human parameters include the customer's gender, height, weight and other human parameters, or the customer's Body Mass Index (BMI).

7. The method defined in claim 6, wherein said mattress specification information includes: mattress thickness, hardness-softness, materials and size.

8. The method defined in claim 7, wherein said subjective comfort questionnaire parameters of subjective evaluation data include: overall satisfaction, coolness, support, level and fitness, the subjective discomfort questionnaire parameters include overall discomfort, discomfort after two hours, discomfort of different body parts and other parameters.

9. The method defined in claim 8, wherein said adjustment parameter selection means could be implemented before or after getting the preliminary data of appropriate mattress sequence with integrated operation processing means; and in the adjustment parameter selection means, the selection method of different preferences can be used as individual operation mode by selecting local options, or used as integrated operation mode by selecting all options.

10. The method defined in claim 9, wherein said mattress purchase method may further consist of a feeling data feedback means, which is used to input and store the feelings of customers as one parameter of the subjective evaluation data.
